(19) United States
(12) Patent Application Publication
(10) Pub. No.: US 2009/0259942 A1
(43) Pub. Date: Oct. 15, 2009

(54) VARYING AN AUDIO CHARACTERISTIC OF AN AUDIBLE NOTICE BASED UPON A PLACEMENT IN A WINDOW STACK OF THE APPLICATION INSTANCE ISSUING THE NOTICE

(75) Inventors: THOMAS F. BITONTI, CARY, NC (US); WENDELL J. BOUKNIGHT, JR., CLAYTON, NC (US); DANA L. PRICE, CARY, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/102,231

(22) Filed: Apr. 14, 2008

(51) Int. Cl. G06F 3/048

(52) U.S. Cl. 715/727

(57) ABSTRACT

An application instance can be identified that is associated with an audible notice, which is to be presented. A placement of the application instance in a window stack can be determined. An audio characteristic (e.g., volume, pitch, speed, repetition, audio channel, etc.) of the audible notice can be adjusted based upon the determined placement in the window stack. Different placements in the windows stack can result in different adjustments. The adjusted audio notice can then be presented.

### BACKGROUND OF THE INVENTION

The present invention relates to the field of user interfaces, more particularly, to varying an audio characteristic (e.g., volume) of an audible notice based upon a placement in a window stack of the application instance issuing the notice.

An increasing number of computing devices implement a multitasking environment, where users can concurrently utilize two or more application instances. Each application instance is generally presented in a discrete window appearing within a graphical user interface (GUI). A mechanism is needed to permit a user to shift from one of these application instances to another. Internally, a window stack keeps track of a relative order of all in-memory windows. A window stack is not necessary implemented as a true “stack”, but instead represents any programmatic artifact able to store an ordered list of elements.

A topmost window on this stack is the “active window” that has focus. Visually, this window is positioned above or is layered on top of other windows in the stack. User input entered through a peripheral (e.g., a keyboard) is by default directed to the active window. User selectable controls exist to permit a user to change an order of the windows in the window stack. For instance, clicking on a partially hidden window, brings this window to the top of the window stack, causes it to be displayed on top of other windows, and grants it the focus property. Alternatively, many operating systems permit a set of keyboard characters (e.g. ALT+TAB) to be entered to cycle through the window stack and to change which window in the stack has focus.

When a user often utilizes multiple windows, it is not uncommon for application instances associated with these windows to issue notifications or notices. These notices are designed to get a user's attention. For example, an email application can be configured to provide notices each time a new email message is received. An instant messaging (IM) application can issue notices when a contact desires to establish an IM session, when a new IM message is received, and the like. Web browsers can issue notifications depending upon any of a set of programmatic events (e.g., virus data base is updated, an attempt to send/receive a message has been blocked, etc.)

Conventional mechanisms for notices are often distracting. For example, a user who receives multiple email messages and corresponding notices often finds these notices more distracting than helpful. Further, when notices are presented from multiple different applications, a user is often unable to easily discern which application issued the notice. For example, a user might want to generally ignore notices from all application instances other than the one having focus. Current notice properties often create notices that are “always on top,” which means that the notice is placed above all other windows in the window stack and seizes focus. A user can often change notification properties to disable “always on top” notifications, which can result in that user missing important notices.

Audio notifications also exist, which are often presented concurrently with visual notifications or in place of the visual notifications. Techniques exist to configure applications to have application specific audible notifications. This can sometimes be helpful to permit a user to discern which application has issued a notice. An importance of the issuing application can, however, shift based upon a position in the window stack. For example, an application user may consider an application instance having focus more important than an application instance deep in the window stack. No known technique provides a variable audible notice that indicates a relative position in the window stack of an application instance that issued the notice.

### BRIEF SUMMARY OF THE INVENTION

One aspect of the present invention can include a system, method, computer program product, and apparatus for providing audible notices. In this aspect, an application instance can be identified that is associated with an audible notice that is to be presented. A placement of the application instance in a window stack can be determined. An audio characteristic (e.g., volume, pitch, speed, repetition, audio channel, etc.) of the audible notice can be adjusted based upon the determined placement in the window stack. Different positions in the windows stack can result in different adjustments. The adjusted audio notice can then be presented.

Another aspect of the present invention can include a multi-tasking system for application notices that includes a window stack, a notice handler, and a digital signal processing (DSP) engine. The window stack can order a set of concurrently running application instances relative to each other. Only one of the concurrently running application instances has focus at a time, which is signified by the order. The notice handler can detect notices issued from at least one of the concurrently running application instances and can present the notice to output components. These notices can include audible notices and the output components can include one or more audio transducers (e.g., speakers). The DSP engine can change at least one audio characteristic (e.g., volume, pitch, speed, repetition, audio channel, etc.) of the audible notices based upon a position that an application instance that issues the notice has in the window stack.

### BRIEF DESCRIPTION OF THE SEVERAL VIEWS OF THE DRAWINGS

FIG. 1 is a schematic diagram of a system where an audio characteristic of an audible notice varies based upon a position in a window stack of a notice issuing application instance in accordance with an embodiment of the inventive arrangements disclosed herein.

FIG. 2 is a flow chart of a method for audibly presenting notices indicative of a position in a window stack of a notice issuing application instance in accordance with an embodiment of the inventive arrangements disclosed herein.

### DETAILED DESCRIPTION OF THE INVENTION

The present invention produces different audible notices that indicate a relative position within a window stack of an application instance that issues the audible notice. The invention can operate in a multitasking environment and with any of a variety of user interface types, including a graphical user interfaces (GUI), a voice user interfaces (VUI), a multimodal interfaces, and the like. The different audible notices can vary in volume or any of a variety of other audio characteristics (e.g., pitch, speed, repetition, audio channel, etc). In one embodiment, a default notice can be adjusted through a digital signal processing (DSP) operation, which varies the audio characteristic so that a user can discern a relative position in a stack. Behavior of the system can be user configured. For example, a user can cause a volume of audible notices to iteratively increase/decrease a volume to reflect a position of an issuing application instance in a window stack. For example, a third of five application instances in a stack can be associated with a volume adjustment (i.e., position in stack divided by total stack instances or 3/5) resulting in a sixty percent decrease from a baseline volume.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

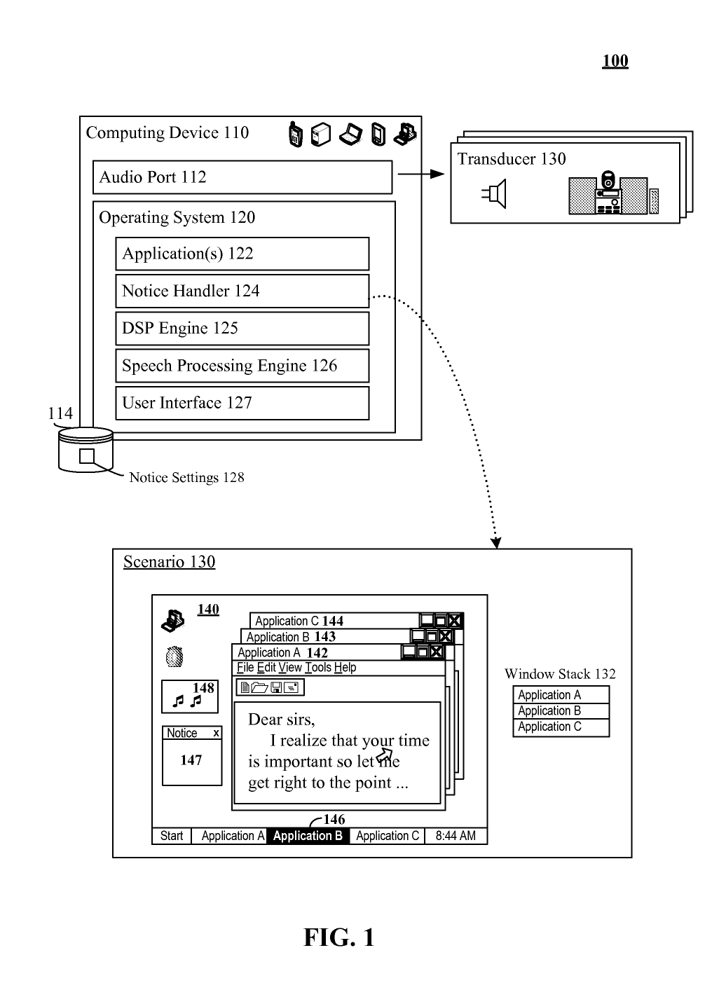

FIG. 1 is a schematic diagram of a system 100 where an audio characteristic of an audible notice varies based upon a position in a window stack of a notice issuing application instance in accordance with an embodiment of the inventive arrangements disclosed herein. In system 100, a computing device 110 can include an operating system 120 capable of running one or more applications 122. Each application 122 can include a user interface 127. The operating system 120 can be a multi-tasking one able to concurrently run multiple application instances, each being an instance of one of the applications 122.

As the application instances run, each can have an associated window. For example, and as shown by scenario 130, three different applications instances 142-144, referred to as Applications A, B, and C, can be concurrently running within a graphical user interface (one embodiment of user interface 127) or an OS desktop 140. A window stack 132 can track a relative ordering of these application instances 142-144 upon the desktop 140. As the application instances execute, one or more of them can issue notices, which are handled by notice handler 124. These notices can include an audible notice 148 as well as an optional visual notice 147. In one embodiment, an optional visual indication 146 can be presented to visually indicate which application instance 142-144 issues a notice 147-148. The audible notices 148 are adjusted by the digital signal processing engine 125 before being presented as audio output via port 112 and via audio transducer 130.

More specifically, DSP engine 125 changes at least one audio characteristic of the audible notice based upon a position in the window stack 132 of an associated application instance. This permits a user hearing the notice to acoustically discern a relative placement of that application instance within the windows stack 132. The audio characteristic can, for example, be a volume adjustment, where the notice volume is inversely (or directly) proportional to a depth of the application instance within the windows stack 132.

Other audio characteristics can be adjusted, such as pitch, speed, repetition, and audio channel. Speed can refer to a playback rate. Repetition can refer to a number of times an audible notice is repeated. For example, an audible notice can be a single tone, which is repeated to represent a position of an application instance in the window stack (i.e., one tone for a first position, two tones for a second position, three tones for a third position, etc.). Audio channel can refer to a subset of speakers to which an audible notice is directed. For example, an audible notice sent to a right channel speaker can indicate a low depth in a window stack 132, an audible notice sent to a left channel speaker can indicate an intermediate depth in the window stack 132, and an audible notice sent to both right and left channel speakers can indicate an issuing application has focus or is on top of the window stack.

It should be appreciated that more than one audio characteristic can be concurrently changed by DSP engine 125. For example, a volume and a repetition can both be changed, where a volume iteratively decreases from the top to the bottom of the stack 132, and the repetition of the notice iteratively increases, once for each position in the stack 132.

In one embodiment, the computing device 110 can utilize a speech processing engine 126 to generate speech audio output. In such an embodiment, additional audio characteristics can be adjusted by the DSP engine 125. For example, voice, gender, head-size, dialect, etc. can be adjusted to distinguish among the various window stack positions. In another embodiment, the speech processing engine 126 can generate speech audio which states a window stack position 132 of an application associated with a notification. Alternatively, an importance level of a notification can be adjusted based at least in part upon a relative position of the issuing application instance in the windows stack 132. This importance level can be audibly presented, spoken, and/or visually indicated within the desktop 140

In one embodiment, a set of notice settings 128 stored in data store 114 can be used. These notice settings 128 can be user configurable and can adjust behavior of the notice handler 124, the DSP engine 125 and/or the speech processing engine 126. For example, the notice settings 128 can specify one or more audio characteristics that are to be adjusted to indicate a relative position in a window stack 132. The notice settings 128 can also specify an algorithm used to adjust the audible notifications, whether adjustments are to be increasing or decreasing based upon different positions in the stack 132, whether adjustments are continuous or level-based (i.e., one volume to indicate a bottom position in stack 132, a different volume to indicate an intermediate position regardless of how many intermediate positions exist, and another volume to indicate a top position in stack 132), and the like. The notice settings 128 can also state that stack position is just one factor of many used to adjust an audio characteristic. For example, different applications 122 can have greater weight than others, and different notification types can also have different weights, where the audio characteristic adjusted by DSP engine 125 is a mathematical result of the various weights and factors. In one configuration, the adjusted audible notice can be designed to indicate a relative importance of a notification, where it is assumed that higher positions in the stack 132 are indicative of greater importance being applied to those application instances relative to application instances occupying a lower stack 132 position.

As shown on desktop 140, Application A is running on top of Application B, which is running on top of Application C. This situation is reflected in the window stack 132 by an Element A (corresponding to Application A) is in a Position 1 (assuming incremental tracking of Application instances from 1 to N) of the stack 132; Element B (corresponding to Application B) is in Position 2; and Element C (corresponding to Application C) is in Position 3. A total of three elements are present in the stack 132. For simplicity's sake, it shall be assumed that the DSP engine 125 is configured (through settings 128) to change the volume of the audible notice based upon position in the stack 132. One such algorithm is to make a volume equal an initial volume divided by the stack position. Thus, an audible notice issued by Application A will have a full volume (initial volume/1=initial volume). An audible notice issued by Application B will have its volume cut in half (initial volume/2). An audible notice issued by Application B will have a volume of one third its original volume (initial volume/3). This example is for illustrative purposes only and any algorithm and/or set of audio characteristics can be adjusted to indicate a relative stack position.

It should be appreciated that although application instances shown in scenario 130 are associated with a desktop 140 stack of windows 142-144 other embodiments are contemplated. For example, an application frame can exist, which includes multiple windows, each corresponding to an “application instance.” For example, a word processing program can permit multiple documents to be concurrently opened within an application frame. Each of these documents represents a distinct application instance specific to that document.

As used herein, audio transducer 130 can be any device or system capable of presenting audio output. For example, the audio transducer 130 can include a set of one or more speakers as well as including a sound system.

Computing device 110 can be any device capable of presenting audible notifications. The computing device 110 can include, but is not limited to, a personal computer, a mobile phone, a server, a tablet, an embedded computing device, a kiosk, and the like.

The operating system 120 can be a multi-tasking operating system capable of concurrently running multiple instances of applications 122. For example, the operating system 120 can be a LINUX operating system, a MACINTOSH operating system, a SOLARIS operating system, a PALM operating system, an embedded or compact operating system, a WINDOWS operating system, and the like.

Application 122 can include any executable computer program product having an associated user interface 127 that is able to execute on the operating system 120. The application can be placed in the windows stack 132 when instantiated, and can be associated and can situationally issue notices. For example, application 122 can include a Web browser, a word processor, a document reader, an eBook application, a Web browser, an email application, an instant messaging application, etc.

DSP engine 125 can be any executable computer program product able to change an audio characteristic of an audio file. These audio characteristics can include volume, pitch, playback rate, audio channel, and the like.

User interface 127 can be an interface that a user can use to interact with application 122. A one-to-one correspondence can exist between interface windows (e.g., windows 142, 143, 144), application instances, and stack 132 elements. The user interface 127 can include a graphical user interface (GUI), a voice user interface (VUI), a multimodal interface, a text only interface, and the like.

The windows stack 132 can be an ordered memory that includes elements for each operational application instance. The order can be an order from a topmost position, which is the window or application instance having focus in the desktop 140. The windows stack 132 can represent a stack of desktop windows, can represent a stack of instances within an application frame, etc.

Data store 114 can be physically implemented within any type of hardware including, but not limited to, a magnetic disk, an optical disk, a semiconductor memory, a digitally encoded plastic memory, a holographic memory, or any other recording medium. Data store 114 can be stand-alone storage units as well as a storage unit formed from a plurality of physical devices, which may be remotely located from one another. Additionally, information can be stored within the data store 114 in a variety of manners. For example, information can be stored within a database structure or can be stored within one or more files of a file storage system, where each file may or may not be indexed for information searching purposes. Additionally, encryption techniques can optionally protect content of data store 114.

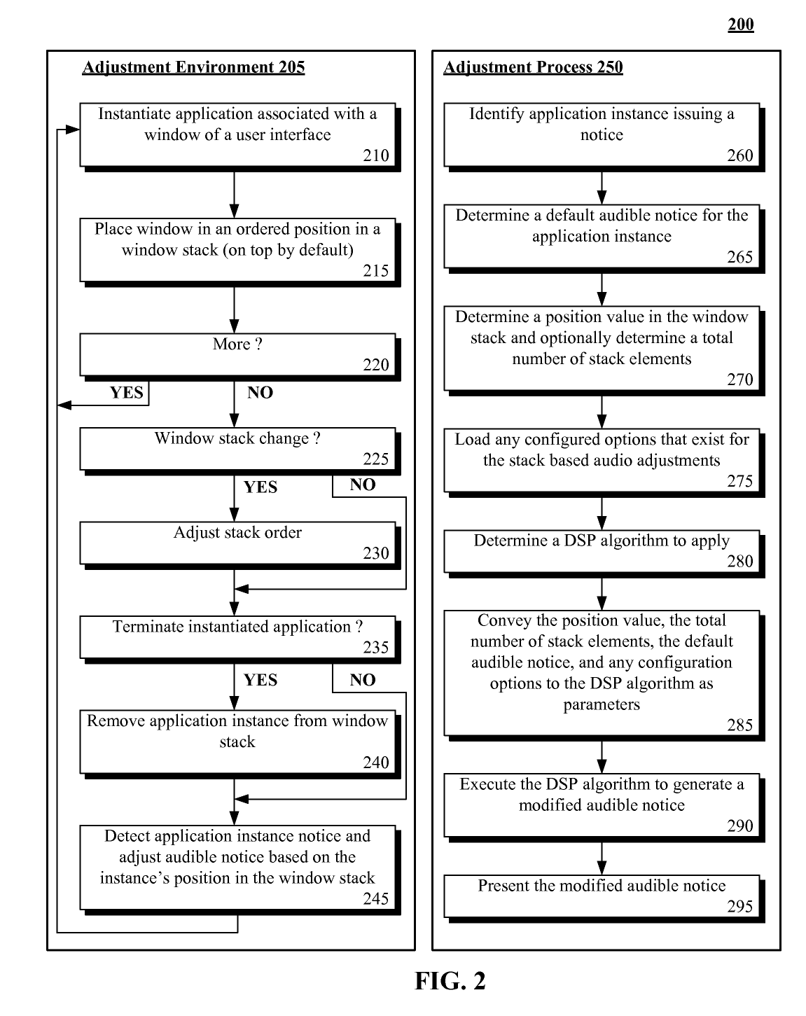

FIG. 2 is a flow chart of a method 200 for audibly presenting notices indicative of a position in a window stack of a notice issuing application instance in accordance with an embodiment of the inventive arrangements disclosed herein. The method 200 can be performed in context of a system 100. In the method 200, elements of a windows stack can be continuously adjusting, as indicated by adjusted environment 205. That is, results of adjustment process 250, which are dependent upon a placement of an application instance in the window stack, vary based upon an environment 205 state.

In adjustment environment 205, an application associated with a window of a user interface can be instantiated, as shown by step 210. In step 215, the window can be placed in an ordered position in a Window stack. Typically newly instantiated windows are placed on top of the window stack. If more applications need to be instantiated, flow can proceed from step 220 back to step 210. Otherwise, flow can proceed to step 225 where a stack navigation action and/or an event changing an order of the window stack can optionally occur. If it does, step 230 can execute and the stack order can be appropriately adjusted. In step 235, one or more operational application instances can be situationally terminated. When terminated, the selected application instance can be removed from the window stack, as shown by step 240. Throughout this repeating process, an application instance notice can be detected, as shown by step 245. For each notice, an audible notice can be adjusted and presented based upon the instance's position in the stack.

Adjustment process 250 provides a more elaborate embodiment of how the adjustment of the audible notice occurs. Process 250 can begin in step 260, where an application instance issuing a notice can be identified. In step 265, a default audible notice for the application instance can be determined. This can be a default audio sample or can be an application specific one, optionally user configured. In step 270, a position value of the identified application instance in a window stack can be determined. A total number of stack elements can be optionally determined at this time. For example, if an application instance is fourth from the top of the window stack containing six active windows, the position value can be four and the total number of stack elements can be six.

In step 275, any configured options that exist for the stack based audio adjustments can be loaded. These options can include user configured options, application configured options, and the like. In step 280, a digital signal processing (DSP) algorithm can be determined. In step 285, the position value, the total number of stack elements, the default audible notice, and any applicable configured options can be passed as parameters to the DSP algorithm. The DSP algorithm can modify any of a variety of audio characteristics of the default audible notice including, but not limited to, volume, pitch, speech, repetition, audio channel, etc. For audible notices including generated speech audio characteristics can also include gender, head-size, dialect, etc. In step 290, the DSP algorithm can execute, which produces a modified audible notice. This modified audible notice can be audibly presented (via a transducer or conveyed to a remote device as a sound file for external handling), as shown by step 295.

The diagrams in FIGS. 1-2 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for providing audible notices comprising:
identifying an application instance associated with an audible notice that is to be presented;
determining a placement of the application instance in a window stack; and
adjusting an audio characteristic of the audible notice based upon the determined placement in the window stack, wherein different placements in the stack result in different adjustments.

2. The method of claim 1, wherein said audio characteristic is a volume.

3. The method of claim 1, wherein said audio characteristic is at least one of a pitch, a speed, a repetition quantity, and an audio channel.

4. The method of claim 1, wherein said window stack is an ordered listing of concurrently executing application instances, wherein a topmost application instance of the ordered listing is an application currently having focus.

5. The method of claim 1, further comprising:
receiving a plurality of user configured settings for adjusting the audio characteristic of application notices based upon a determined placement in a window stack; and
applying said user configured settings when adjusting the audio characteristic.

6. The method of claim 1, further comprising:
ascertaining a default audible notice for the identified application instance;
determining an audio adjustment based upon the determined placement;
when adjusting the audio characteristic, performing a digital signal processing (DSP) operation against the default audible notice to create a modified audio notice; and
audibly presenting the modified audio notice.

7. The method of claim 6, wherein the determining of the audio adjustment, the adjusting of the audio characteristic, and the performing of the digital signal processing operation are Operating System level changes performed to a default audible notice associated with the application instance.

8. The method of claim 1, wherein each application instance is an instance executing in a multi-tasking operating system.

9. A computer program product for providing audible notices comprising, a computer usable medium having computer usable program code embodied therewith, the computer usable program code comprising:
computer usable program code configured to identify an application instance associated with an audible notice that is to be presented;
computer usable program code configured to determine a placement of the application instance in a window stack; and
computer usable program code configured to adjust an audio characteristic of the audible notice based upon the determined placement in the window stack, wherein different placements in the stack result in different adjustments.

10. The computer program product of claim 9, wherein said audio characteristic is a volume.

11. The computer program product of claim 9, wherein said audio characteristic is at least one of a pitch, a speed, a repetition quantity, and an audio channel.

12. The computer program product of claim 9, further comprising:
computer usable program code configured to ascertain a default audible notice for the identified application instance;
computer usable program code configured to determine an audio adjustment based upon the determined placement;
computer usable program code configured to perform a digital signal processing (DSP) operation against the default audible notice to create a modified audio notice when adjusting the audio characteristic; and
computer usable program code configured to audibly present the modified audio notice.

13. The computer program product of claim 9, wherein each application instance is an instance executing in a multi-tasking operating system.

14. A multi-tasking system for application notices comprising:
a window stack configured to order a plurality of concurrently running application instances relative to each other, wherein only one of said concurrently running application instances has focus at a time, which is signified by said order;
a notice handler configured to detect notices issued from at least one of the concurrently running application instances and configured to present said notice to output components, wherein said notices comprise audible notices; and
a digital signal processing (DSP) engine configured to change at least one audio characteristic of said audible notices based upon a position that an application instance that issues the notice has in the window stack.

15. The system of claim 14, further comprising:
at least one digital signal processing (DSP) algorithm used by said digital signal processing engine, wherein variable parameters used by said DSP algorithm comprise a position value and a total number of stack elements, wherein said position value corresponds to a position of the application instance that issued the notice in the window stack, and wherein the total number of stack elements represents a total number of elements, each corresponding to an application instance, in the window stack.

16. The system of claim 15, wherein said variable parameters further comprise a default audible notice, and at least one user configured notice setting.

17. The system of claim 14, wherein said audio characteristic is a volume.

18. The system of claim 14, wherein said audio characteristic is at least one of a pitch, a speed, a repetition quantity, and an audio channel.

19. The system of claim 14, further comprising:
A speech processing engine configured to generate speech included within the audible notice.

20. The system of claim 19, wherein said audio characteristic is at least one of gender of a speech generation voice, head-size of a speech generation voice, and dialect of a speech generation voice.
